(19) United States
(12) Patent Application Publication
(10) Pub. No.: US 2022/0252466 A1
(43) Pub. Date: Aug. 11, 2022

(54) EAR-POD TYPE THERMOMETER

(71) Applicants: Chun-Liang Yeh, New Taipei City 247 (TW); Chia-Hua Lin, New Taipei City 247 (TW); Mei-Jou Huang, New Taipei City 247 (TW); Shu-Ni Lee, New Taipei City 247 (TW)

(72) Inventors: Chun-Liang Yeh, New Taipei City 247 (TW); Chia-Hua Lin, New Taipei City 247 (TW); Mei-Jou Huang, New Taipei City 247 (TW); Shu-Ni Lee, New Taipei City 247 (TW)

(21) Appl. No.: 17/170,517

(22) Filed: Feb. 8, 2021

(51) Int. Cl. G01K 13/20; G01K 1/024; H04R 1/10

(52) U.S. Cl. CPC G01K 13/20; G01K 1/024; H04R 2420/07; H04R 1/1041; H04R 1/1091; H04R 1/1016

(57) ABSTRACT

An ear-pod type thermometer includes a base and an ear part. The ear part is inserted into a user's ear. The ear part includes a temperature sensor which detects the user's temperature. The base includes at least one light emitting member which displays different colors of light responsive to the detected temperature, so that the wearer's temperature can be displayed and easily monitored.

### BACKGROUND OF THE INVENTION

### 1. Fields of the Invention

The present invention relates to an ear thermometer, and more particularly, to an ear-pod type thermometer.

### 2. Descriptions of Related Art

Body temperature is one of the important basis for judging the condition of the human body, especially when many epidemic diseases occur. Monitoring body temperature at any time is a necessary daily measurement action. Thermometers become a necessary product, and includes a first type which is the ear temperature, and the second type is the forehead temperature. The body temperature is obtained by reaching the thermometer close to the ear canal or forehead. However, all of the thermometers need to be held by one hand. Besides, it is inconvenient to carry, the thermometers can only record and measure the temperature of a single time and cannot record continuously. Moreover, the thermometers are currently displayed in digital format. If the measured body temperature value is in a gathering place or a building with a large number of people, it is necessary to measure the body temperature one by one when entering. It takes too much time due to the need to check one by one.

The present invention intends to provide an ear-pod type thermometer to eliminate the shortcomings mentioned above.

### SUMMARY OF THE INVENTION

The present invention relates to an ear-pod type thermometer and comprises a base and an ear part. The base includes a processor and a power supply. At least one light emitting member and a switch are located on outside of the base. The ear part is connected to the outside of the base and includes at least one temperature sensor. The ear part is inserted into a user's ear, and the at least one temperature sensor detects the user's temperature. The at least one light emitting member emits light to display detected temperature.

The primary object of the present invention is to provide an ear-pod type thermometer which includes an ear part inserted into the use's ear. The ear-pod type thermometer displays different colors of light responsive to the detected temperature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ear-pod type thermometer of the present invention;

FIG. 2 illustrates the components of the ear-pod type thermometer of the present invention;

FIG. 3 is another perspective view to show the ear-pod type thermometer of the present invention;

FIG. 4 shows that a user is using the ear-pod type thermometer of the present invention;

FIG. 5 shows embodiments of the light emitting member of the ear-pod type thermometer of the present invention;

FIG. 6 shows an embodiment of the ear-pod type thermometer of the present invention;

FIG. 7 shows another perspective view to show the ear-pod type thermometer in FIG. 6;

FIG. 8 shows the components of the ear-pod type thermometer of the present invention displayed in FIGS. 6 and 7, and

FIG. 9 shows that the ear-pod type thermometer of the present invention is worked with a smart device.

### DETAILED DESCRIPTION OF THE PREFERRED EMBODIMENT

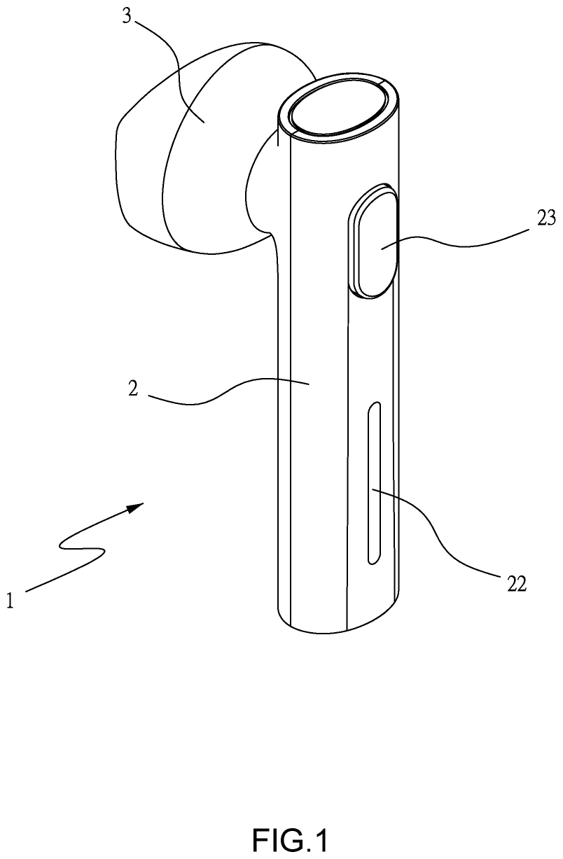

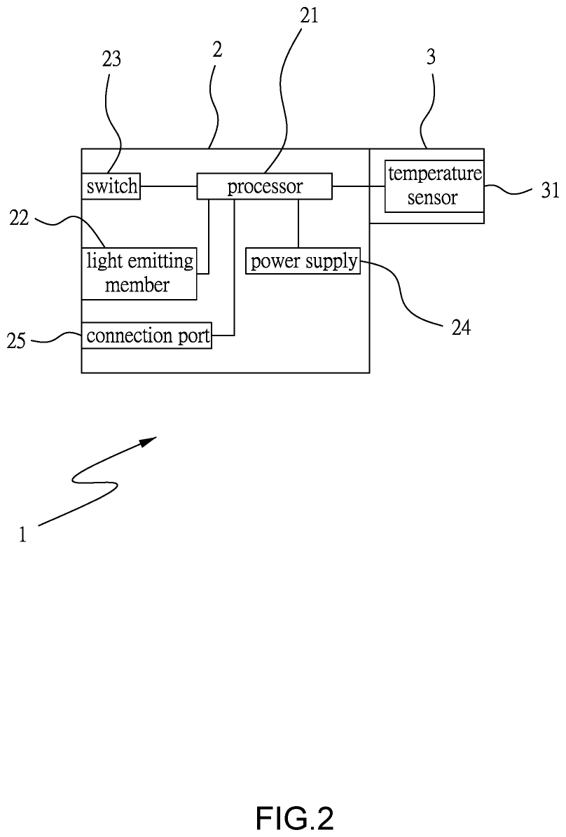

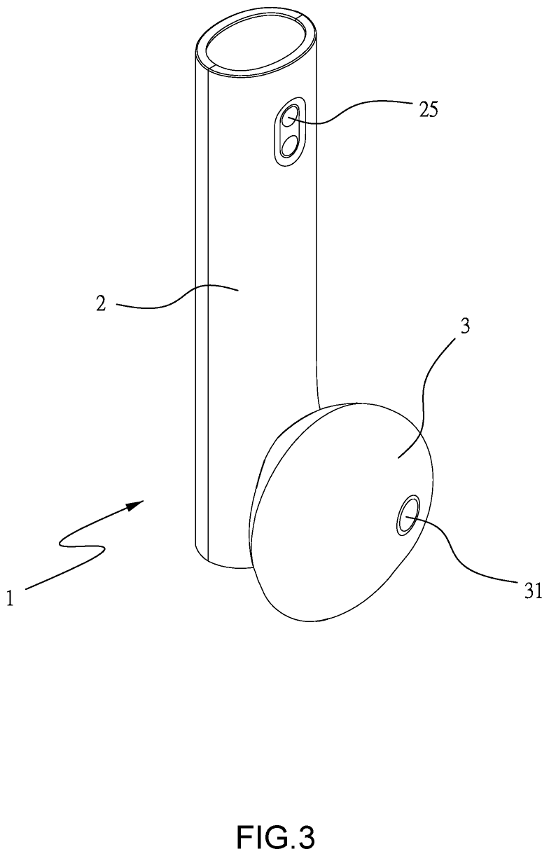

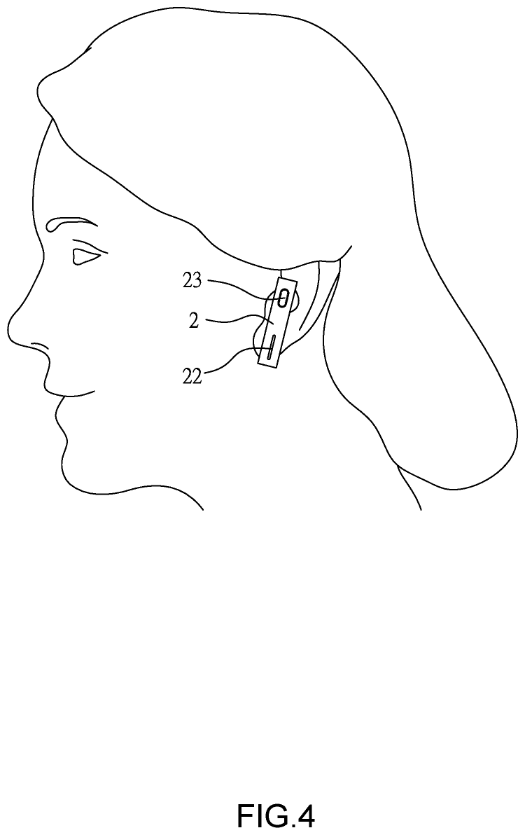

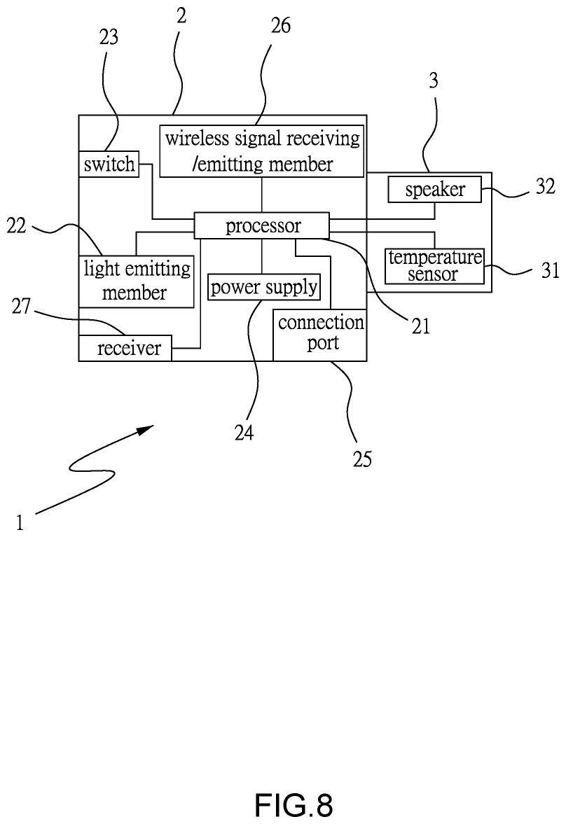

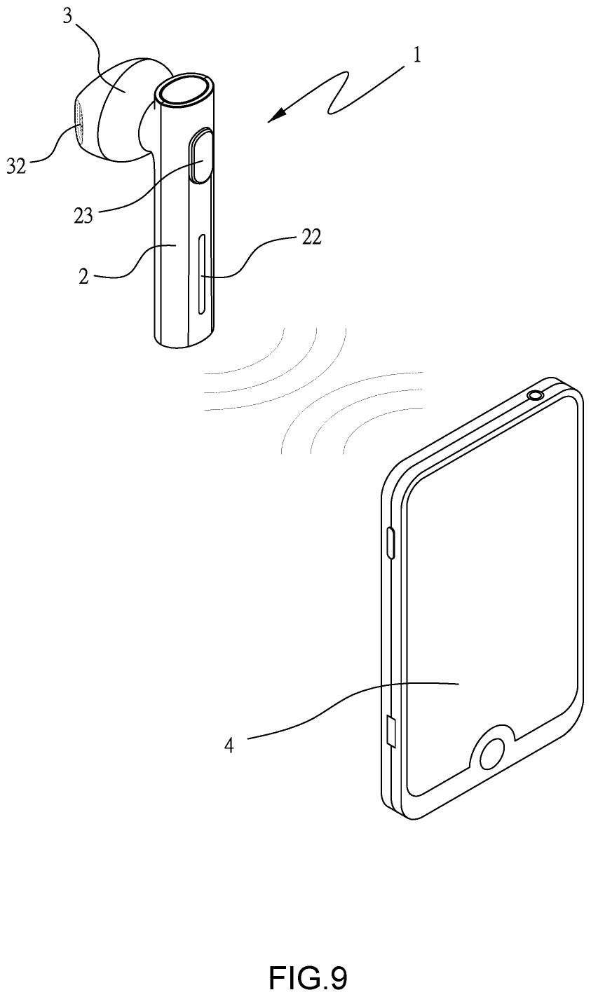

Referring to FIGS. 1 to 9, the ear-pod type thermometer 1 of the present invention comprises a base 2 having a processor 21 and a power supply 24. The processor 21 processes detected data. At least one light emitting member 22 and a switch 23 are located on outside of the base 2.

An ear part 3 is connected to the outside of the base 2 and includes at least one temperature sensor 31 formed to the surface of the ear part 3. The ear part 3 is to be inserted into a user's ear, and the at least one temperature sensor 31 is positioned to detect the user's temperature. The at least one light emitting member 22 emits light to display the detected temperature.

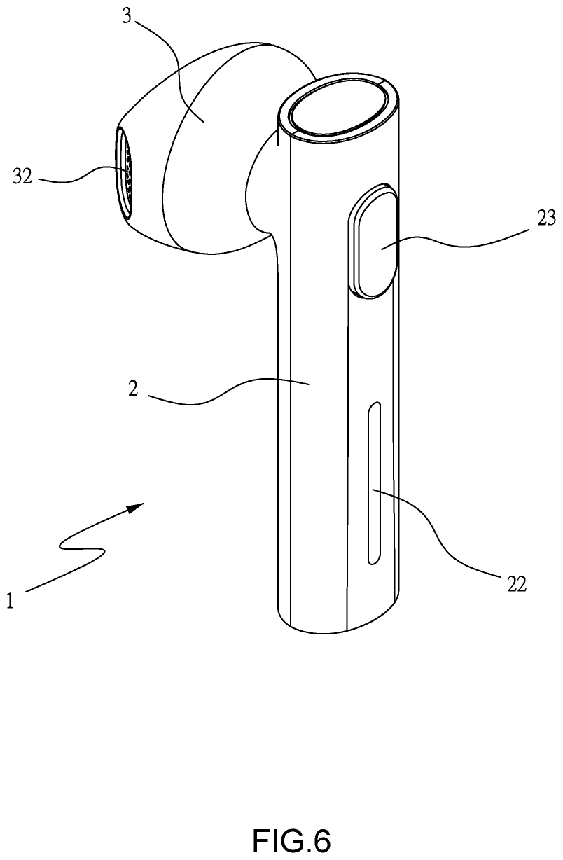

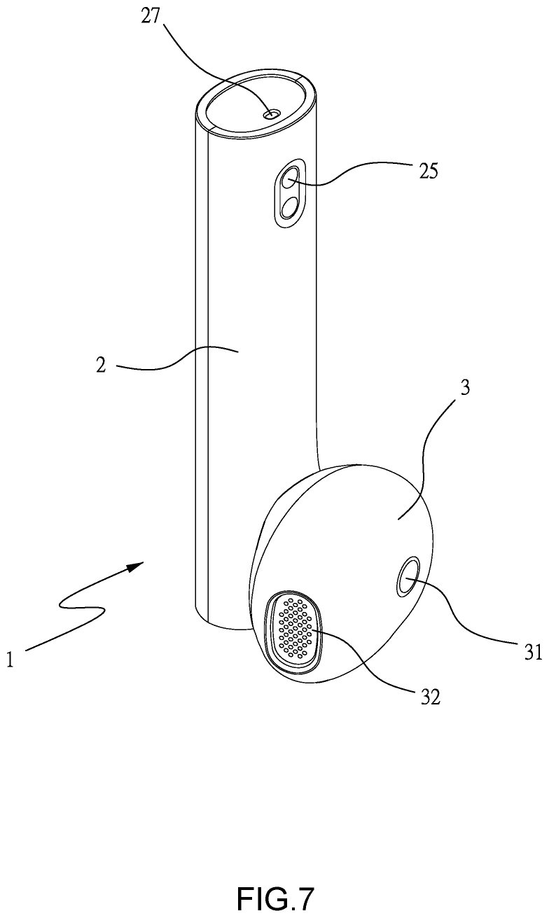

Preferably, the at least one light emitting member 22 emits different colors of light. The at least one light emitting member 22 is one of a pattern, a character and a symbol. The base 2 is an elongate base, and the at least one light emitting member 22 and the switch 23 are located opposite to the ear part 3 on the base 2. The base 2 includes a connection port 25 formed to the outside thereof and the connection port 25 is located at the same side as the ear part 3. The base 2 further includes a wireless signal receiving/emitting member 26 therein. The ear part 3 includes a speaker 32 as shown in FIG. 6. A receiver 27 is formed to the outside of the base 2 as shown in FIG. 7. Preferably, the receiver 27 is formed to a distal end of the base 2 and located away from the ear part 3.

When in use, the ear part 3 is inserted in the user's ear canal, and the base 2 is located outside of the user's ear. The at least one temperature sensor 31 formed to the surface of the ear part 3 detects the user's temperature. The detected temperature is displayed by the at least one light emitting member 22 so that the user's temperature can be easily monitored.

The detected temperature/signal is sent to the processor 21 in the base 2, the processor 21 processes the detected signal and drives the at least one light emitting member 22 to emits light of different colors responsive to the detected temperature. For instance, the at least one light emitting member 22 emits green light responsive to the detected temperature of 35 to 36.8 degrees Celsius, yellow light responsive to the detected temperature of 36.81 to 37.5 degrees Celsius, and red light responsive to the detected temperature higher than 37.5 degrees Celsius. It is noted that the colors of the light emitted is not limited to the examples mentioned above. In addition, the at least one light emitting member 22 can also be used to display the level of the power supply 24 when the at least one light emitting member 22 is not used to detect temperature.

The switch 23 is not just used to control the operation of the ear-pod type thermometer 1, the switch 23 can also be used to adjust the lighting frequency of the at least one light emitting member 22, and the detection frequency of the temperature sensor 31.

The connection port 25 on the base 2 is used to be connected with a charging device to charge the ear-pod type thermometer 1.

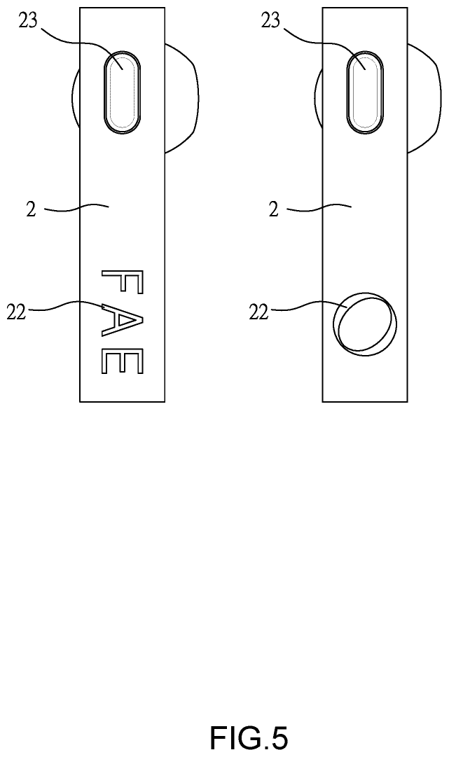

As shown in FIG. 5, the at least one light emitting member 22 is one of a pattern, a character and a symbol. The different styles of the at least one light emitting member 22 can be used for advertisement or for displaying personality.

By inserting the ear part 3 in the user's ear canal, and by the light displayed by the at least one light emitting member 22 of the base 2, the temperature can be easily displayed so that the present invention is suitable for monitoring mass number of people such as used to monitor people in music events, sport events, museums, gathering events, schools, factories or business or office buildings. The use of the present invention allows the monitors to check the temperature of individuals entering or leaving the buildings. Of more importance is that the present invention avoids the shortcomings of conventional remote or non-contact thermometers which may not function properly due to movement of shaking. Because the present invention is inserted into the ear canal so that the detected temperature by the ear-pod type thermometer 1 of the present invention is effective and accurate.

As shown in FIGS. 6 to 9, the base 2 further includes a wireless signal receiving/emitting member 26 therein as shown in FIG. 6. A receiver 27 is formed to the outside of the base 2 as shown in FIG. 7. The wireless signal receiving/emitting member 26 can be cooperated with a smart device 4 so that the detected temperature is transferred to the smart device 4 for record and being monitored. Of course, the smart device 4 needs an application or software to be worked with the ear-pod type thermometer 1 of the present invention so as to display the detected temperature. The receiver 27 of the base 2 allows the user to talk and control the application or software of the smart device 4 so as to operate the ear-pod type thermometer 1 of the present invention. The smart device 4 is able to turn on or turn off the ear-pod type thermometer 1 of the present invention, to change the light frequency of the at least one light emitting member 22, to active or de-active the wireless signal receiving/emitting member 26, and to active or de-active the receiver 27.

The speaker 32 of the ear part 3 generates audio when the wireless signal receiving/emitting member 26 is connected with the smart device 4. That is to say, when the user wears the ear-pod type thermometer 1 of the present invention, not only the user's temperature can be detected, the speaker 32 is used as an ear-pod to play music.

While we have shown and described the embodiment in accordance with the present invention, it should be clear to those skilled in the art that further embodiments may be made without departing from the scope of the present invention.

What is claimed is:

1. An ear-pod type thermometer 1 comprising:
a base having a processor and a power supply, at least one light emitting member and a switch located on outside of the base;
an ear part connected to the outside of the base and including at least one temperature sensor, and
the ear part adapted to be inserted into a user's ear, the at least one temperature sensor adapted to detect the user's temperature, the at least one light emitting member emitting light to display detected temperature.

2. The ear-pod type thermometer as claimed in claim 1, wherein the at least one light emitting member emits different colors of light.

3. The ear-pod type thermometer as claimed in claim 1, wherein the at least one light emitting member is one of a pattern, a character and a symbol.

4. The ear-pod type thermometer as claimed in claim 1, wherein the base includes a connection port formed to the outside thereof.

5. The ear-pod type thermometer as claimed in claim 1, wherein the base includes a wireless signal receiving/emitting member therein.

6. The ear-pod type thermometer as claimed in claim 1, wherein the base includes a receiver formed to the outside thereof.

7. The ear-pod type thermometer as claimed in claim 1, wherein the ear part includes a speaker.
